(19) United States
(12) Patent Application Publication
(10) Pub. No.: US 2010/0060184 A1
(43) Pub. Date: Mar. 11, 2010

(54) METHOD AND SYSTEM FOR OPERATING A GAS DISCHARGE LAMP

(75) Inventors: Engbert Bernard Gerard Nijhof, Eindhoven (NL); Marcel Johannes Maria Bucks, Eindhoven (NL); Jozef Petrus Emanuel De Krijger, Eindhoven (NL); Cong Khanh Pham, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/302,040

(22) PCT Filed: May 10, 2007
(86) PCT No.: PCT/IB2007/051766

§ 371 Date: Mar. 30, 2009

(30) Foreign Application Priority Data
May 31, 2006 (EP) 06114768.2
Jan. 19, 2007 (EP) 07100816.3

(51) Int. Cl. H05B 41/288

(52) U.S. Cl. 315/246

(57) ABSTRACT

In an application of a gas discharge lamp (La) arranged at a relatively large distance from its driving lamp driver circuit, parasitic capacitances (C_{GR,1}, C_{GR,2}) between the wiring (W1, W2) and ground may result in a current flowing to other parts of the lamp driver circuit, which may result in incorrect operation of the lamp driver circuit. In particular, if the gas discharge lamp is ignited using a resonant circuit for generating a relatively high ignition voltage such incorrect operation may result. In accordance with the present invention, a first alternating voltage is generated at a first lamp terminal (O1) and a second alternating voltage is generated at a second lamp terminal (O2), such that the voltage across the lamp terminals is equal to the sum of the first and the second alternating voltages. Thereto, a resonant inductance of the resonant circuit is embodied as a first and a second inductor (L1a, L1b), each coupled to a respective lamp terminal of the gas discharge lamp.

### FIELD OF THE INVENTION

The present invention relates to a method and system for operating a gas discharge lamp, and in particular for operating a gas discharge lamp arranged at a relatively large distance from a lamp driver circuit.

### BACKGROUND OF THE INVENTION

In specific applications, e.g. outdoor applications such as a lamp post, a gas discharge lamp that is to be operated by a suitable lamp driver circuit is arranged at a relatively large distance from the lamp driver circuit. Consequently, relatively large wires are used to connect the lamp and the lamp driver circuit. This wiring results in a relatively large parasitic capacitance between the wires and between each of the wires and ground. Although the relatively large parasitic capacitance between the wires may not substantially influence the operation of the lamp driver circuit and the lamp, the parasitic capacitance of each of the wires and ground may influence the operation, in particular during ignition.

For ignition, a relatively high voltage may be generated, e.g. using a resonant circuit. In a known embodiment, the relatively large voltage is generated at one of the lamp terminals. Such a configuration thus leads to a relatively large current flowing through the respective parasitic capacitance to ground. Due the high voltage, this current may be a high current, which may return to the lamp driver circuit through an unknown ground (earth) impedance and a common mode filter of a power factor correction circuit (inductance) of the lamp driver circuit. In such a resonant circuit, the current returning to the lamp driving circuit may significantly damp or disturb the original resonant ignition circuit, due to which no well-controlled ignition voltage is applied to the lamp.

### OBJECT OF THE INVENTION

It is desirable to have a lamp driver circuit and a lamp driving method wherein a parasitic current flowing to ground does not influence the operation of the lamp driving circuit.

### SUMMARY OF THE INVENTION

The present invention provides a method according to claim 1 and a lamp driver circuit according to claim 3.

In the method and the lamp driver circuit according to the present invention, the inductance of the resonant circuit is embodied as two inductors. A first inductor is connected to a first lamp terminal and a second inductor is connected to a second lamp terminal. The first and the second inductors are arranged such that a first alternating voltage is generated at the first lamp terminal and a second alternating voltage is generated at the second lamp terminal, wherein the first alternating voltage and the second alternating voltage have an opposite polarity, i.e. are 180° phase shifted with respect to each other. Consequently, the voltage across the lamp is equal to the sum of the amplitudes of the first and the second alternating voltage. Preferably, the first and the second inductors are selected such that the first alternating voltage and the second alternating voltage have a substantially equal amplitude.

Since a voltage is generated at both lamp terminals, a parasitic current flows between each lamp wire and ground through the respective parasitic capacitances. Since the phase of the first and the second alternating voltage have an opposite polarity, the direction of each of the parasitic currents is reversed with respect to each other. For example, if a first parasitic current flows from a first lamp wire to ground, a second parasitic current flows from ground to a second lamp wire. If the first and the second alternating voltages have a substantially equal amplitude, the first and the second parasitic currents are substantially equal. The current flowing from the first lamp wire to ground may flow through ground to the second lamp wire. Hence, the current flowing to ground does not return to the lamp driver circuit, thereby preventing that the ignition voltage is damped or disturbed or that parts of the lamp driver circuit are disturbed by the return current.

In an embodiment, the first inductor and the second inductor are magnetically coupled. The magnetic component can be tuned to have a specific value for the leakage inductance for compensating leakage currents due to differences in parasitic or additional filter components, such as a (parasitic) capacitance.

### BRIEF DESCRIPTION OF THE DRAWINGS

Hereinafter the present invention is elucidated in more detail with reference to the appended drawings illustrating non-limiting embodiments, wherein

FIG. 1 shows a basic circuit diagram of a lamp driver circuit having a resonant circuit;

FIG. 2 shows a circuit diagram of a first embodiment of a lamp driver circuit according to the present invention; and

FIG. 3 shows a circuit diagram of a second embodiment of a lamp driver circuit according to the present invention.

### DETAILED DESCRIPTION OF EXAMPLES

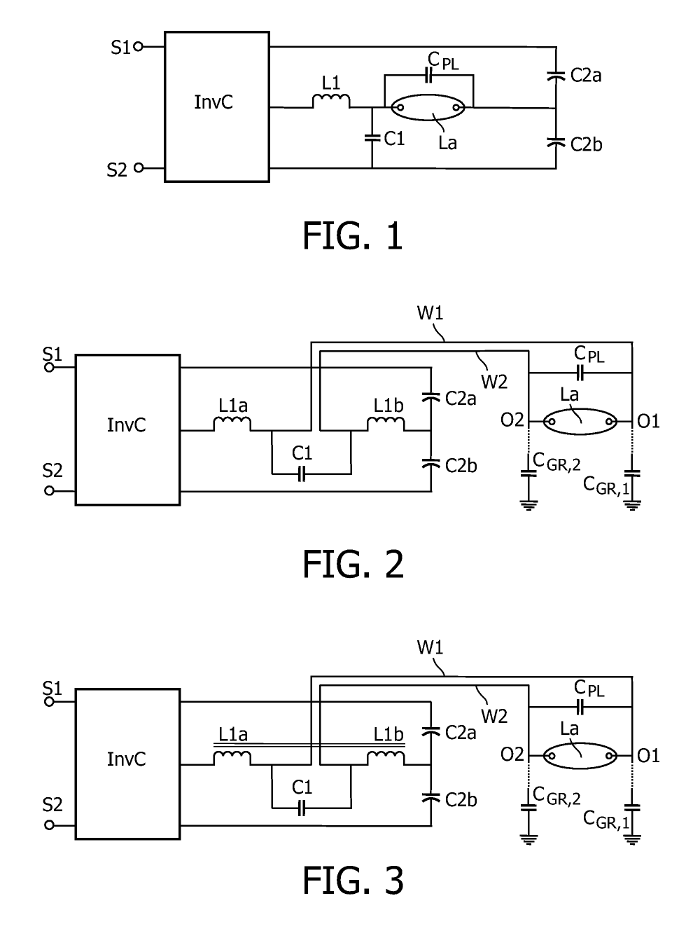

In the drawings like reference numerals refer to like components. FIG. 1 shows a circuit diagram of a lamp driver circuit having a resonant circuit for igniting a gas discharge lamp La. The lamp driver circuit comprises an inverter circuit InvC having a first and a second supply voltage terminal S1, S2 for receiving a suitable supply voltage. The inverter circuit InvC generates a suitable alternating current, which is supplied to the output circuit. The output circuit comprises the resonant circuit, the lamp La and a first and a second output capacitor C2a, C2b. The resonant circuit comprises a resonant inductor L1 and a resonant capacitor C1. The lamp La and the wiring to the lamp La is illustrated to have a lamp capacitance C_{PL}. The lamp capacitance C_{PL} is intended to include any parasitic capacitance resulting from wiring to the lamp La. If the lamp La is arranged near the lamp driver circuit, the parasitic capacitance may be neglected.

In operation, during ignition, substantially no current flows through the lamp La, thus providing a relatively large impedance. Consequently, the resonant inductor L1 and the resonant capacitor C1 may resonate, depending on a frequency of the alternating current supplied by the inverter circuit InvC and a resonance frequency of the resonant circuit. When resonating, a relatively high voltage is generated at a node between the resonant inductor L1 and the resonant capacitor C1, which node is connected to a first lamp terminal. Thus, a relatively high voltage is applied to the first lamp terminal, thereby applying a relatively high voltage across the lamp La. The relatively high voltage across the lamp La may result in ignition of the lamp La. After ignition of the lamp La, the impedance of the lamp La is small. The alternating current supplied by the inverter circuit InvC thus flows through the lamp La, resulting in a steady state operation. It is noted that the frequency of the alternating current supplied by the inverter circuit InvC may be different for igniting and for steady state operation, as is known from the prior art.

In FIGS. 2 and 3, it is assumed that the lamp La is arranged at a relatively large distance from the lamp driver circuit, as indicated by the first lamp wire W1, and the second lamp wire W2. Therefore, compared to the circuit of FIG. 1, the capacitance of the lamp capacitance C_{PL} is relatively large. Further, due to the relatively long wires W1, W2, a first parasitic capacitance C_{GR,1} and a second parasitic capacitance C_{GR,2} are present between ground and a first lamp terminal O1 and a second lamp terminal O2, respectively.

In the embodiment of FIG. 2, the resonant inductance comprised in the resonant circuit is embodied in accordance with the present invention as a first and a second resonant inductor L1a, L1b (cf. the resonant inductor L1 in the lamp driver circuit of FIG. 1). The first resonant inductor L1a and the second resonant inductor L1b are separated. The first resonant inductor L1a is connected with the first lamp terminal O1; the second resonant inductor L1b is connected with the second lamp terminal O2. The resonant capacitance C1 is connected in parallel with the lamp terminals O1 and O2 and hence with the lamp La.

As mentioned above, long wiring such as wires W1, W2 may introduce a parasitic capacitance C_{GR,1}, C_{GR,2} between the wires W1, W2 and ground. The parasitic capacitors C_{GR,1}, C_{GR,2} may influence the operation of the lamp driver circuit, in particular during ignition mode when a relatively high voltage is generated across the lamp La. If an (alternating) high voltage is generated at one of the lamp terminals, e.g. output terminal O1, in accordance with the prior art, a current flows from the output terminal O1 to ground through the capacitor C_{GR,1}. Due the high voltage, this current may be a high current which may return to the lamp driver circuit through an unknown ground (earth) impedance and/or a common mode filter of a power factor correction circuit (inductance). In such a resonant circuit the current returning to the lamp driver circuit may significantly damp or disturb the original resonant ignition circuit due to which no well controlled ignition voltage is applied to the lamp La.

Referring to FIG. 2 again, in the ignition mode, an alternating high voltage is generated between the output terminals O1 and O2 for igniting the gas discharge lamp La. Using two substantially similar inductors L1a and L1b, preferably magnetically coupled in accordance with the embodiment as illustrated in FIG. 3, a substantially same alternating high voltage is generated at each lamp terminal O1, O2. Further, the circuit is configured such that the alternating voltage at the lamp terminal O1 has an opposite polarity compared to the alternating voltage at the lamp terminal O2 (i.e. 180° phase shifted). Hence, the voltage across the lamp terminals O1 and O2 is twice as high as the alternating voltage at each separate lamp terminal O1, O2.

Further, during the ignition mode, due to the alternating high voltages at the lamp terminals O1, O2, a parasitic current flows from the lamp terminal O1 to ground and a parasitic current flows from ground to the lamp terminal O2. Since the voltages at the lamp terminals O1 and O2 are substantially the same, only having an opposite polarity, the current flowing from the first lamp terminal O1 to ground may flow through ground to the second lamp terminal O2. Hence, the current flowing to ground does not return to the lamp driver circuit (but returns to the other lamp terminal), thereby preventing that the ignition voltage is damped or disturbed or that parts of the lamp driver circuit are disturbed by the return current.

Further, due to, inter alia, the construction of the gas discharge lamp La and an influence of external factors like a fixture and the surrounding earth (ground), in gas discharge lamps, there may be a difference during ignition of the gas discharge lamp La depending on the electrode on which the ignition voltage is applied. The above lamp driver circuit configuration according to the present invention takes away this disadvantage, since the voltage at each electrode is substantially the same except for the phase shift. This is advantageous in particular in outdoor applications. In outdoor applications like lamp posts, the lamp wires W1, W2 may be connected to the lamp driver circuit at a lower end of the lamp post by a less skilled person and/or a person working under difficult conditions such as bad lighting conditions, wind, rain, cold, heat.

A further advantage is found in that the first and second resonant inductors L1a and L1b may form a symmetrical filter. If the first and second resonant inductors L1a and L1b are magnetically coupled the magnetic component can be tuned to have a specific value for the leakage inductance.

Although detailed embodiments of the present invention are disclosed herein, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Further, the terms and phrases used herein are not intended to be limiting; but rather, to provide an understandable description of the invention. The terms “a” or “an”, as used herein, are defined as one or more than one. The term another, as used herein, is defined as at least a second or more. The terms including and/or having, as used herein, are defined as comprising (i.e., open language). The term coupled, as used herein, is defined as connected, although not necessarily directly, and not necessarily by means of wires.

1. Method for igniting a gas discharge lamp (La), the method comprising:
generating a first alternating high voltage at a first lamp terminal (O1) of the gas discharge lamp; and
generating a second alternating high voltage at a second lamp terminal (O2) of the gas discharge lamp, the second alternating high voltage having an opposite polarity compared to the first alternating high voltage.

2. Method according to claim 1, wherein the first alternating high voltage and the second alternating high voltage have a substantially equal amplitude.

3. Lamp driver circuit for operating a gas discharge lamp (La), the lamp driver circuit being configured for generating an ignition voltage for igniting the gas discharge lamp using a resonant circuit, the resonant circuit comprising an inductance (L1) and a capacitance (C1), wherein the inductance comprises a first inductor (L1a) and a second inductor (L1b), the first inductor being arranged to be coupled to a first lamp terminal (O1) of the gas discharge lamp and the second inductor being arranged to be coupled to a second lamp terminal (O2) of the gas discharge lamp such that during ignition a first alternating high voltage is generated at the first lamp terminal and a second alternating high voltage having an opposite polarity compared to the first alternating high voltage is generated at the second lamp terminal.

4. Lamp driver circuit according to claim 3, wherein the first inductor and the second inductor have a substantially same number of turns such that the first alternating high voltage and the second alternating high voltage have a substantially equal amplitude.

5. Lamp driver circuit according to claim 3, wherein the first inductor and the second inductor are magnetically coupled.

6. Lamp driver circuit according to claim 3, wherein the capacitance of the resonant circuit comprises a capacitor (C1) coupled between the first lamp terminal and the second lamp terminal.
